(19) United States
(12) Patent Application Publication
(10) Pub. No.: US 2026/0091565 A1
(43) Pub. Date: Apr. 2, 2026

(54) SYSTEM FOR SEALING ELEMENTS FOR AIRCRAFTS

(71) Applicant: Airbus Operations S.L.U., GETAFE (ES)

(72) Inventors: Carlos SUAREZ TORRENTS, Getafe (ES); Sebastián PALOS RIVAS, GETAFE (ES)

(21) Appl. No.: 19/345,136

(22) Filed: Sep. 30, 2025

(30) Foreign Application Priority Data
Oct. 1, 2024 (EP) 24383059.3

(51) Int. Cl. B29C 70/54; B29C 70/44; B29L 31/30

(52) U.S. Cl. CPC B29C 70/544; B29C 70/44; B29L 2031/3076

(57) ABSTRACT

A sealing system with a guide that guides a pair of layers and heating rollers that apply heat and pressure to an edge of the layers for sealing the layers to each other, the heating rollers movable along the edge. Also a method which includes aligning a pair of layers so that a portion of one of the layers is placed in front of a portion of the other layer, defining an edge, applying heat and pressure to the edge of the layers by heating rollers, and moving the heating rollers along the edge of the layers, sealing both layers to each other at the edge, forming a vacuum bag.

### CROSS-REFERENCES TO RELATED APPLICATIONS

This application claims the benefit of European Patent Application Number 24383059.3 filed on Oct. 1, 2024, the entire disclosure of which is incorporated herein by way of reference.

### FIELD OF THE INVENTION

The present invention relates to a sealing system and method for closing vacuum bags, in particular, in the field of aerospace manufacturing, specifically for sealing of vacuum bags used in the manufacturing process of aircraft composite parts, such as wing covers, and other potential parts where a vacuum bag in direct contact with the composite part is used.

### BACKGROUND OF THE INVENTION

Some components of an aircraft are composite parts that are manufactured using vacuum bags that are placed in direct contact with the composite part. Examples of this kind of composite part include wing covers and stringers, among others.

Current methods for sealing vacuum bags in aircraft composite parts manufacturing imply the use of sealant tape. This tape is manually checked and corrected during the integration of the composite parts, such as stringers, requiring operators to climb onto the cover and kneel among numerous caul plates.

These traditional methods not only pose safety risks for the operators but also rely heavily on manual labor, limiting the potential for automation.

Additionally, the auxiliary materials used in these methods often adhere to the part during an autoclave process, leading to defects and increasing the need for deburring and repairs.

The inability to automate the sealing process effectively impacts both the safety and efficiency of the overall manufacturing process.

### SUMMARY OF THE INVENTION

Therefore, an object of the present invention is to provide a sealing system and method that solves the problem of labor-intensive sealing methods by introducing an automated sealing system that uses a zipper-like approach for vacuum bag closure.

The sealing system and method of the invention solves the above-mentioned disadvantages and has other advantages which will be described below.

The sealing system and method according to the present invention are described in the corresponding independent claims, and the dependent claims include additional features that are optional.

In particular, the sealing system for closing vacuum bags comprises:
a guide that guides a pair of layers that form the vacuum bag; and
sealing/heating rollers that apply heat and pressure to an edge of the layers for sealing the layers to each other, forming the vacuum bag, said sealing/heating rollers being movable along said edge.

Preferably, the sealing system according to the present invention also comprises a support that holds the sealing/heating rollers.

Furthermore, the sealing system can also comprise a control module that controls the temperature and pressure applied to the edge of the layers by the heating rollers, and the speed of the heating rollers along said edge.

Preferably, the sealing system for closing vacuum bags according to the present invention can also comprise an injection nozzle that injects a gas into the vacuum bag formed by the layers.

According to a second aspect, the sealing method for closing vacuum bags comprises the following steps:
aligning a pair of layers so that a portion of one of the layers is placed in front of a portion of the other layer, defining an edge;
applying heat and pressure to said edge of the layers by heating rollers; and
moving said heating rollers along the edge of the layers, sealing both layers to each other at said edge, forming a vacuum bag.

Furthermore, the method also comprises preferably a step of setting the temperature, pressure and speed of the heating rollers before applying heat and pressure and moving said heating rollers.

The sealing method for closing vacuum bags according to the present invention can also comprise a step of testing the vacuum bag formed, e.g. injecting a gas inside the vacuum bag.

Furthermore, the method also comprises preferably a step of placing the layers on at least one aircraft composite part.

The sealing system and method according to the present invention ensure a consistent and secure seal of the vacuum bags, reducing the need for operators to perform manual corrections on the manufacturing cradles.

Therefore, the sealing system and method according to the present invention provide at least the following advantages:
Increased Efficiency: The sealing process is faster compared to manual methods.
Health & Safety Improvements: Eliminates the need for operators to perform tasks on the manufacturing cradles of covers, enhancing their safety.
Material Savings: Eliminates the use of auxiliary materials like sealant tape, preventing it from adhering to the part during autoclaving, thus reducing defects in deburring and minimizing non-conformities and repairs, which leads to improvements in quality and cost savings.

### BRIEF DESCRIPTION OF THE DRAWINGS

For a better understanding of what has been explained above, some drawings are included in which, schematically and only by way of a non-limiting example, a practical case of embodiment is represented.

FIG. 1 is a diagrammatical view of the sealing system according to the present invention, in particular for sealing vacuum bags during the manufacture of aircraft stringers.

### DETAILED DESCRIPTION OF THE PREFERRED EMBODIMENTS

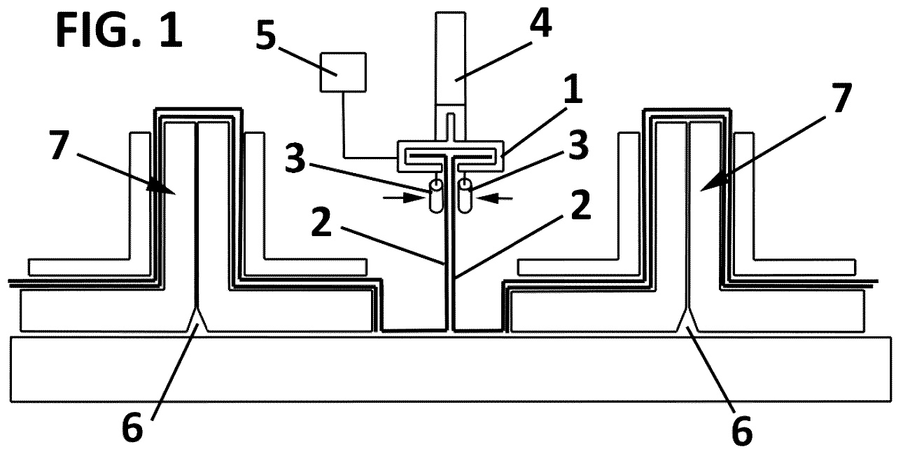

FIG. 1 shows a diagrammatical view of the sealing system according to the present invention, in particular for sealing vacuum bags during the manufacture of two adjacent aircraft stringers.

The sealing system according to the present invention is designed for the closure of vacuum bags used in composite material manufacturing, such as aircraft composite parts.

The sealing system ensures a consistent and secure seal lifting, aligning, and sealing a vacuum bag of two adjacent stringers.

The sealing system comprises a guide 1 that lifts and aligns two layers 2, e.g. of nylon film, that form the vacuum bag, to ensure they are properly positioned for sealing, and heating rollers 3 that are positioned immediately after the guide 1. These heating rollers 3 apply precise heat and pressure to seal the layers 2 together.

The sealing system also comprises a support 4, that is a framework that holds the heating rollers 3 and allows for adjustments to ensure consistent sealing pressure and alignment.

Furthermore, the sealing system also comprises motors and rails, not shown in the drawing, that control the movement of the heating rollers 3 along the edge of the layers 2, preferably at a constant speed.

The sealing system also includes a control module 5, that monitors and adjusts the temperature, pressure, and speed of the sealing process, i.e., of the heating rollers 3 to maintain optimal conditions. The unravelling of the vacuum bag formed by the layers 2 is also preferably controlled.

The sealing system is preferably used with nylon layers, but it can also be used with layers of any other suitable material.

An example of the sealing method according to the present invention is now described, for example, for sealing a vacuum bag for an aircraft wing lower cover or between two adjacent stringers 7, as shown in FIG. 1.

First, a preparation step is carried out, in which the layers 2 to be sealed are positioned on the composite parts to be bagged with the vacuum bag, and the system parameters such as the temperature, pressure and speed of the heating rollers 3 are set.

Then, the guide 1 lifts and aligns the layers 2 with the heating rollers 3 in a root joint section, preparing them for sealing.

Once aligned, the sealing is carried out, moving the layers 2, so that the heating rollers 3 apply heat, for example, at approximately 185° C., and pressure, creating a secure seal.

Finally, vacuum tests are conducted to ensure the integrity of the seal, injecting a gas, e.g., helium, by an injection nozzle 6, between the layers 2 forming the vacuum bag and the stringers 7, according to the depicted embodiment.

The sealing system is designed to handle the typical thickness of nylon layers used in vacuum bagging. For instance, an initial thickness may be reduced during the sealing process, ensuring no porosity or the formation of holes form.

Hereinafter, a further explanation with respect to nylon layers is provided.

When thermoplastic materials like nylon are heat-sealed, they behave as viscous fluids.

The mass of the material before and after the sealing process remains constant. The mass is a product of density (p), area (A), and thickness (h):

$$ρ \cdot {A}_{initial} \cdot {h}_{initial} = ρ \cdot {A}_{final} \cdot {h}_{final}$$

Assuming constant density and area, the equation simplifies to:

$${A}_{initial} \cdot {h}_{initial} = {A}_{final} \cdot {h}_{final}$$

The deformation in thickness is due to the viscous flow of the material under heat and pressure. According to Newton's law of viscosity:

$$- r = μ \cdot ( dy / du ) ,$$

where:
−r is the shear stress.
μ is the dynamic viscosity.
(dy/du) is the velocity gradient perpendicular to the direction of shear.

The applied pressure (P) directly influences the shear stress (−r) applied to the material. Higher pressure increases the stress, leading to greater deformation and thinning of the material.

The sealing temperature (T) affects the viscosity (μ) of the material. As temperature increases, viscosity decreases, allowing the material to flow more easily under pressure→μ(T).

To derive a formula considering pressure and temperature, we start with the relationship between shear stress and pressure:

$$- r = P$$

Assuming a steady-state flow and using the conservation of mass:

$${h}_{final} = {h}_{initial} / ( 1 + ( P \cdot t ) / μ$$

where:
t is the time under pressure.
μ(T) is the viscosity at temperature T.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A sealing system for closing vacuum bags, the sealing system comprising:
a guide configured to guide a pair of layers that form a vacuum bag; and
heating rollers configured to apply heat and pressure to an edge of the pair of layers for sealing the pair of layers to each other and thereby form the vacuum bag, said heating rollers configured to move along said edge.

2. The sealing system for closing vacuum bags according to claim 1, further comprising:
a support holding the heating rollers.

3. The sealing system for closing vacuum bags according to claim 1, further comprising:
a control module configured to control a temperature and the pressure applied to the edge of the pair of layers by the heating rollers, and a speed of the heating rollers along said edge.

4. The sealing system for closing vacuum bags according to claim 1, further comprising:
an injection nozzle configured to inject a gas into the vacuum bag formed by the pair of layers.

5. A method for closing vacuum bags, the method comprising the steps of:
aligning a pair of layers so that a portion of one of the layers of the pair of layers is placed in front of a portion of the other layer of the pair of layers and thereby defining an edge;
applying heat and pressure to said edge of the pair layers by heating rollers; and
moving said heating rollers along the edge of the pair of layers, sealing the pair of layers to each other at said edge and thereby forming a vacuum bag.

6. The method for according to claim 5, further comprising a step of:
setting a temperature, the pressure and a speed of the heating rollers before the steps of applying heat and pressure and moving said heating rollers.

7. The method for according to claim 5, further comprising a step of:
testing the vacuum bag formed.

8. The method for according to claim 7, wherein said testing step comprises injecting a gas inside the vacuum bag.

9. The method for according to claim 5, further comprising a step of:
placing the pair of layers on at least one aircraft composite part.
